(19) United States
(12) Patent Application Publication
(10) Pub. No.: US 2009/0107282 A1
(43) Pub. Date: Apr. 30, 2009

(54) HANDLE MECHANISM AND LOCK

(75) Inventor: Stuart Mangham, Western Australia (AU)

Correspondence Address: MERCHANT & GOULD PC, P.O. BOX 2903, MINNEAPOLIS, MN, 55402-0903, US

(73) Assignee: Woodleigh Investments Pty Ltd, Bedfordale (AU)

(21) Appl. No.: 12/093,359

(22) PCT Filed: Nov. 13, 2006
(86) PCT No.: PCT/AU2006/001689

§ 371 Date: Nov. 17, 2008

(30) Foreign Application Priority Data
Nov. 11, 2005 (AU) 2005906257

(51) Int. Cl. G05G 1/04; B25G 3/12; B62B 11/00

(52) U.S. Cl. 74/491; 74/503; 280/47.34

(57) ABSTRACT

A lock (50) particularly suitable for selectively locking a handle (30) in any one or more of the available positions. The lock (50) comprises a locking pin (51) moveable axially along a first axis (52) between engaging and release conditions. The locking pin (51) is operably connected to a slider (71) adapted to undergo reciprocatory movement along a second axis (72) substantially normal to the first axis (52), whereby movement of the slider (71) along the second axis (72) causes movement of the locking pin (51) along the first axis (52). A handle mechanism (10) incorporating the lock (50), and apparatus (11) fitted with the handle mechanism (10), are also disclosed.

### FIELD OF THE INVENTION

This invention relates to a lock and also to a handle mechanism incorporating such a lock, as well as apparatus fitted with such a handle mechanism.

### BACKGROUND ART

There are various types of mobile apparatus which incorporate a handle by means of which the apparatus can be propelled across a surface such as the ground. Such mobile apparatus include lifting jacks, trolley jacks, lawn mowers and floor sanders.

With some such apparatus, the handle may be pivotally moveable between a plurality of available positions according to the requirements of a user, and there may be a need to selectively lock the handle in any one or more of the available positions.

A common way of locking a handle in a selected one of the available positions is to provide a locking pin on the handle for movement between engaging and release conditions with respect to a plurality of locking holes provided in an adjacent surface fixed with respect to the handle. The locking holes are disposed in an arcuate arrangement so that the locking pin can register, and engage with, any of the locking holes to releasably lock the handle in the position corresponding to the selected locking hole. An operating mechanism is provided for moving the locking pin between the engaging and release conditions. Typically, the operating mechanism comprises a cable operably connected to the locking pin, or a cam mechanism actuatable in response to an actuating force, to move the locking pin between the engaging and release positions.

For certain applications, space limitations may preclude use of a cable or cam mechanism for operating the locking pin.

It is against this background, and the problems and difficulties associated therewith, that the present invention has been developed.

The preceding discussion to the invention is intended only to facilitate an understanding of the present invention. It should be appreciated that the discussion is not an acknowledgement or an admission that any of the material referred to was or is part of the common general knowledge in Australia as at the priority date of the application.

### DISCLOSURE OF THE INVENTION

According to a first aspect of the invention there is provided a lock comprising a locking pin moveable axially along a first axis between engaging and release conditions, a slider adapted to undergo reciprocatory movement along a second axis substantially normal to the first axis, the slider being operably connected to the locking pin whereby movement of the slider along the second axis causes movement of the locking pin along the first axis.

Preferably, the slider presents a pair of opposed faces disposed angularly with respect to the second axis, the opposed faces being adapted for sliding engagement with abutment faces on the locking pin.

Preferably, the locking pin incorporates a slot in which the slider is received, the opposed faces of the slot defining the abutment faces.

Preferably, guide means are provided for guiding the slider during reciprocatory movement thereof.

The guide means may comprise a carriage defined by the slider confined between two opposed guide tracks.

According to a second aspect of the invention there is provided a handle mechanism incorporating a lock according to the first aspect of the invention.

According to a third aspect of the invention there is provided a handle mechanism comprising a handle pivotally moveable into and out of a first position and a lock for releasably locking the handle in the first position, the lock comprising a locking pin moveable between engaging and release conditions and an actuator operably connected to the locking pin whereby the locking pin is moveable from the engaging conditions into the release conditions upon operating of the actuator, the handle comprising a tubular shaft and the actuator comprising an elongate element accommodated within the tubular shaft, one end of the elongate element being operably connected to the locking pin and the other end of the elongate element being connected to an actuating device (such as an actuating handle).

Preferably, the elongate element comprises a rigid shaft.

Preferably, the locking pin is moveable axially along a first axis between the engaging and release conditions.

Preferably, the lock further comprises a slider adapted to undergo reciprocatory movement along a second axis substantially normal to the first axis, the slider being operably connected to the locking pin whereby movement of the slider along the second axis causes movement of the locking pin along the first axis.

Preferably, the slider presents a pair of opposed faces disposed angularly with respect to the second axis, the opposed faces being adapted for sliding engagement with abutment faces on the locking pin.

Preferably, the locking pin incorporates a slot in which the slider is received, the opposed faces of the slot defining the abutment faces.

Preferably, guide means are provided for guiding the slider during reciprocatory movement thereof.

According to a fourth aspect of the invention there is provided apparatus adapted to be propelled across the ground or other surface, the apparatus having a handle according to the third aspect of the invention.

According to a fifth aspect of the invention there is provided apparatus comprising a mobile portion and a handle mechanism for propelling the mobile portion, the handle mechanism comprising a handle pivotally moveable into and out of a first position with respect to the mobile portion and a lock for releasably locking the handle in the first position, the lock comprising a locking pin moveable between engaging and release conditions with respect to the mobile portion and an actuator operably connected to the locking pin whereby the locking pin is moveable from the engaging conditions into the release conditions upon operating of the actuator, the handle comprising a tubular shaft and the actuator comprising an elongate element accommodated within the tubular shaft, one end of the elongate element being operably connected to the locking pin and the other end of the elongate element being connected to an actuating device

### BRIEF DESCRIPTION OF THE DRAWINGS

The invention will be better understood by reference to the following description of one specific embodiment thereof as shown in the accompanying drawings in which:

FIG. 1 is a front perspective view of a lifting jack incorporating a handle mechanism according to the embodiment;

FIG. 2 is a side elevational view of the lifting jack;

FIG. 3 is a fragmentary front elevational view of the handle mechanism according to the embodiment, illustrating in particular a lock for releasably locking the handle mechanism in a selected locking position;

FIG. 4 is a fragmentary perspective view of the handle mechanism, illustrating in particular the lock for releasably locking the handle mechanism in a selected locking position, with a locking pin forming part of the lock being shown in an engaging condition;

FIG. 5 is a view similar to FIG. 4 with the exception that the locking pin is shown in the release condition;

FIG. 6 is a schematic sectional view of the lock with the locking pin in the engaging condition;

FIG. 7 is a view similar to FIG. 6 with the exception that the locking pin is in the release condition;

FIG. 8 is a longitudinal sectional view of the locking pin;

FIG. 9 is a longitudinal sectional view of a support barrel supporting the locking pin for axial sliding movement; and

FIG. 10 is a fragmentary view of the lower end of an actuating rod and a slider connected thereto.

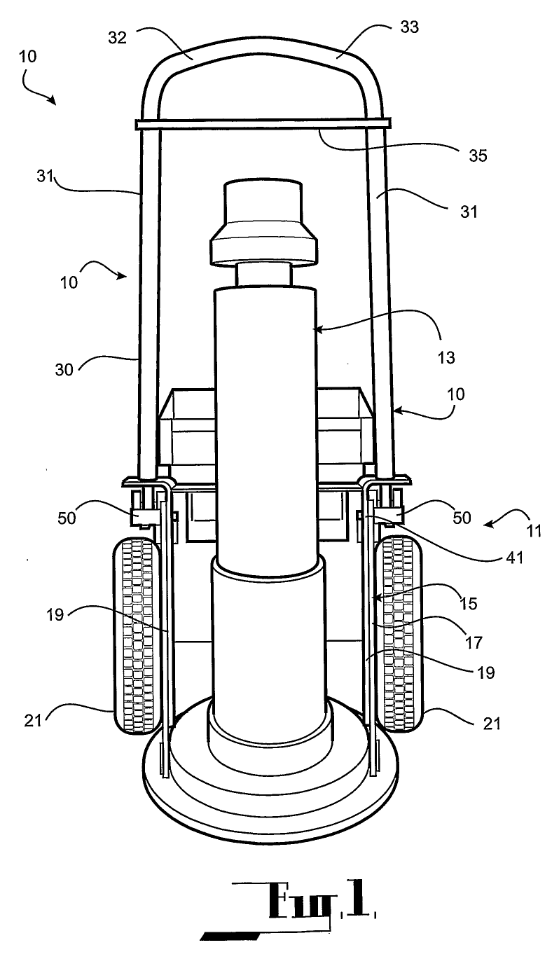

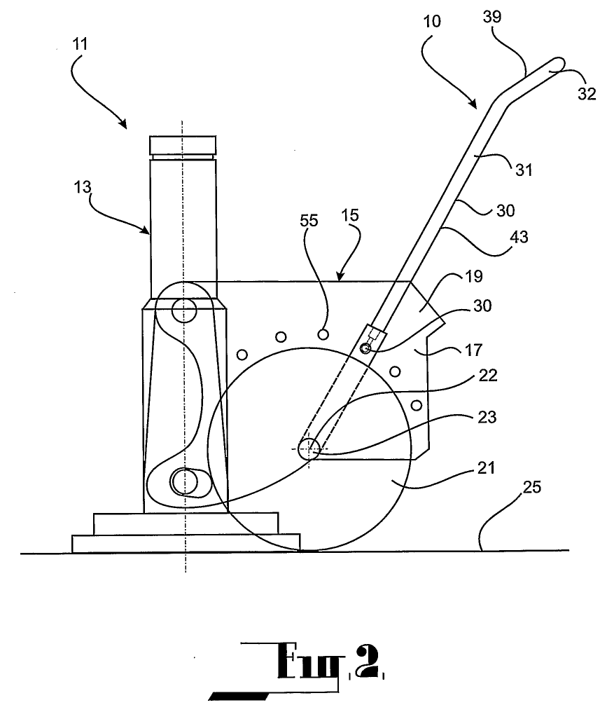

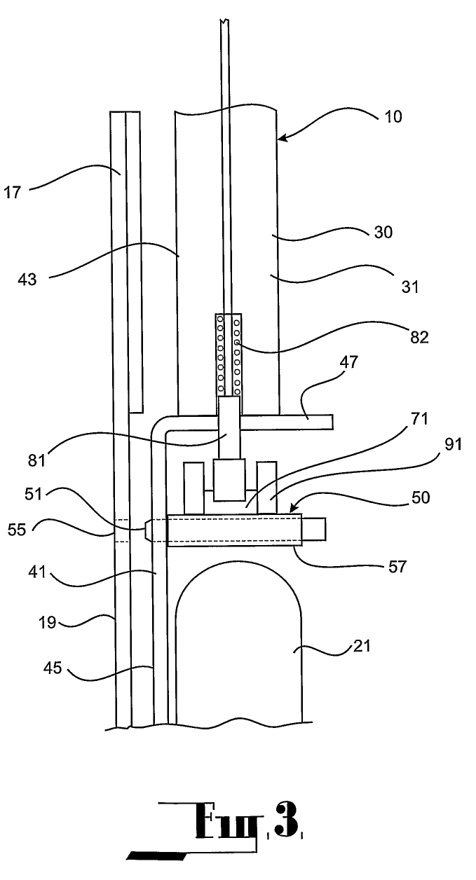

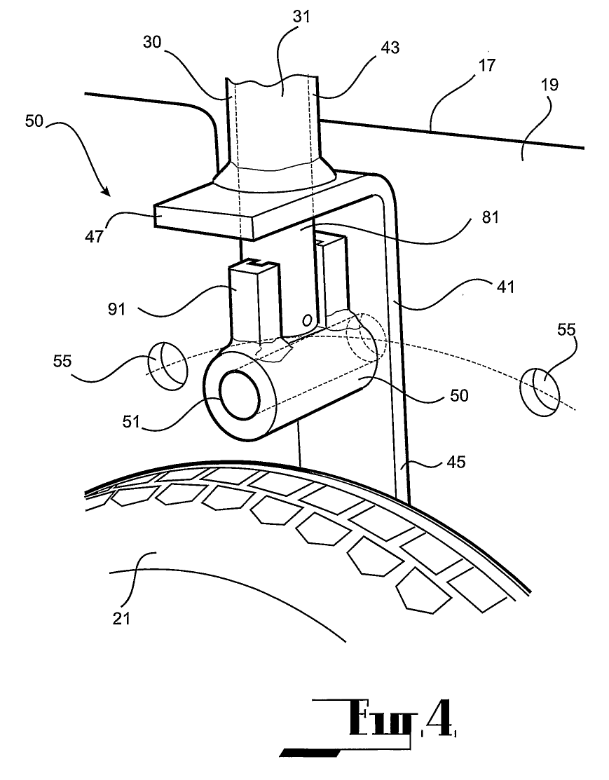

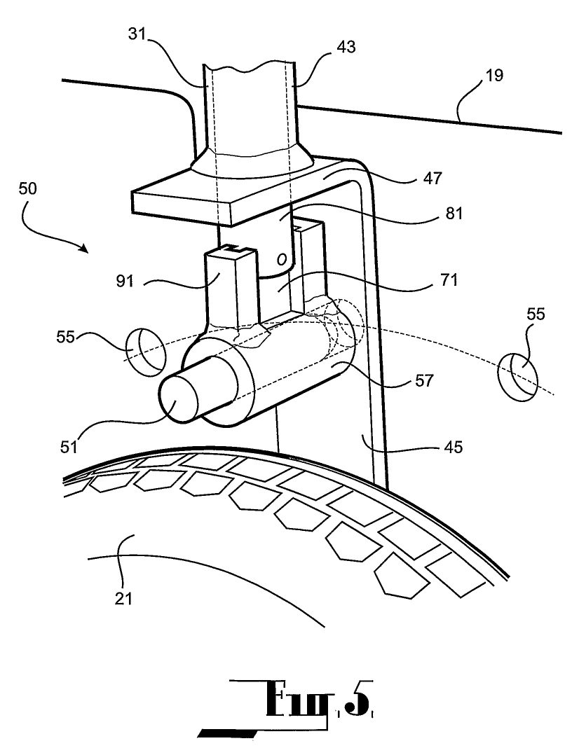

### BEST MODE(S) FOR CARRYING OUT THE INVENTION

The embodiment shown in the drawings is directed to a handle mechanism 10 for moving mobile apparatus across a surface (such as the ground or a floor surface). In the arrangement shown, the mobile apparatus comprises a lifting jack 11 of the type disclosed in the Applicant's International Application PCT/AU2006/000561, the contents of which are incorporated herein by way of reference. The lifting jack 11 comprises a jacking portion 13 carried on a mobile frame 15. The mobile frame 15 comprises a housing 17 which has two opposed sides 19 and which is supported on ground wheels 21. The ground wheels 21 are mounted for rotation about a substantially horizontal axis 22 on stub axles 23 carried by the housing 17. The handle mechanism 10 is provided for propelling the mobile frame 15 across the surface 25.

The handle mechanism 10 comprises a handle 30 having two side portions 31 and an upper portion 33 extending between the side portions 31 to provide a handgrip 32. The handle 30 also incorporates a lever bar 35 extending between the side portions 31 and supported for limited lateral movement, thereby functioning as a pull handle (the purpose of which will be explained later).

Each side portion 31 of the handle 30 is connected at its lower end to a respective one of the stub axles 23 and is rotatable about the stub axles for angular movement with respect to the housing 17. Each side portion 31 comprises a lower section 41 and an upper section 43. The lower section 41 is connected to the respective the stub axle 23 for rotation about the stub axle. The lower section 41 comprises a bar 45 pivotally mounted at its lower end onto the stub axle 23. The bar 45 extends upwardly from the stub axle 23 closely adjacent the respective side 19 of the housing 17 and is turned outwardly at its upper end to provide a bracket 47. The upper section 43 of the side portion 31 of the handle 30 is secured to the bracket 47 and is of tubular construction.

Because the bars 45 are pivotally mounted on the stub axles 23, the handle 30 can pivot about the stub axles 23 (that is, about axis 22). Locks 50 are provided on the two side portions 31 of the handle mechanism 10 for releasably locking the handle 30 in a selected one of a plurality of available angular positions. The particular angular position selected is dependant upon the needs of the user and the particular function that the trolley jack 11 is to perform.

Each lock 50 comprises a locking pin 51 supported for axial movement (along a first axis 52) between engaging and release conditions with respect to a plurality of locking holes 55 provided in the adjacent side 19 of the housing 17. With this arrangement, the locking pin 51 can be moved into registration with any one of the locking holes 55 and moved from the release position into the engaging position to be received in a selected one of the holes, thereby locking the handle 30 with respect to the mobile frame 15 at the corresponding handle position.

The locking pin 51 is supported for axial sliding movement in a support barrel 57 mounted at one end on the outer side of the bar 45. The barrel defines a bore 59 for slidingly supporting the locking pin 51 for axial movement (along the first axis 52) between engaging and release conditions.

The barrel 57 has an outer wall 61, and an inner wall 62 defining the bore 59 in which the locking pin 51 is slidably accommodated. A first slot 63 extends between the outer and inner walls 61, 62 of the barrel 57. A second slot 64, which is in opposed relation to the first slot 63, also extends between the outer and inner walls 61, 62 of the barrel 57.

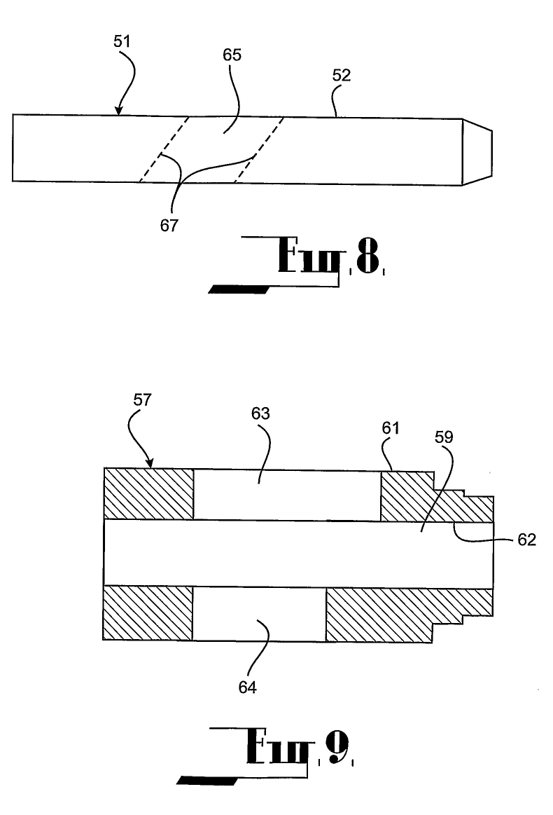

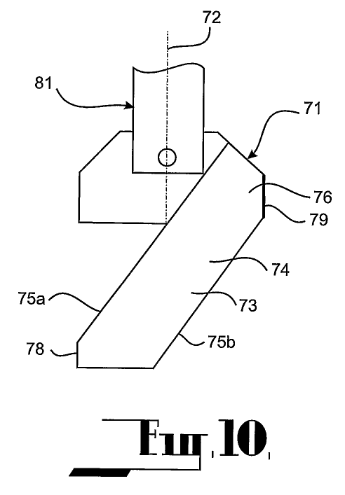

The locking pin 51 comprises a cylindrical body 52 having a transverse slot 65 extending obliquely therethrough, the ends of the slot 65 defining abutment faces 67. The abutment faces 67 are inclined to the longitudinal axis of the pin, as best seen in FIG. 8.

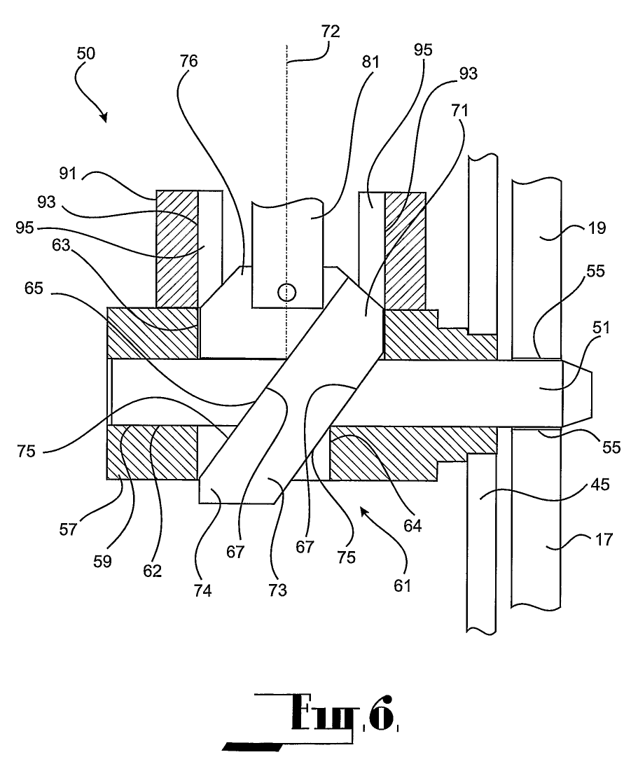

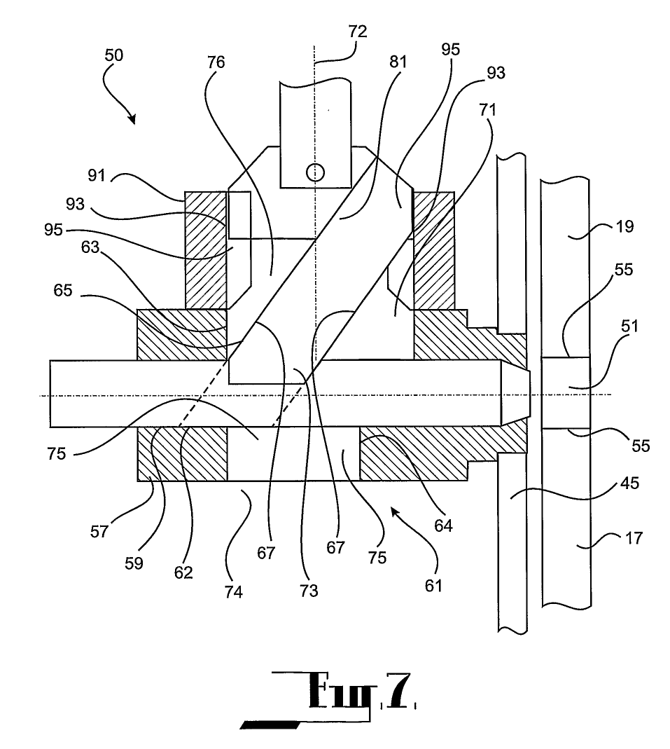

The lock 50 further comprises a slider 71 supported for reciprocatory movement along second axis 72 transverse to the longitudinal axis of the locking pin (i.e. the first axis 52). The slider 71 comprises an operating portion 73 configured as a finger 74 and a carriage portion 76 from which the finger 74 projects. The finger 74 is configured and dimensioned to be received within the slot 65 in the locking pin 41. The finger 74 presents two opposed inclined faces 75 disposed angularly with respect to the direction of reciprocatory movement of the slider 71 (i.e. the second axis 72), an axial face 78 extending from inclined face 75a and a further axial face 79 extending from inclined face 75b. The opposed inclined faces 75 are adapted for sliding engagement with the respective abutment faces 67 at the ends of the slot 65 in the locking pin 61 within which the finger 74 is received. The axial faces 78, 79 slide against the respective sides of slots 63, 64 as best seen in FIGS. 6 and 7.

The finger 74 is accommodated in the second slot 64 when the slider 61 is in its lowermost position (as shown in FIG. 6).

The slider 71 is connected to the lower end of an actuating rod 81, the upper end of which is connected to the lever bar 35. The actuating rod 81 extends between the slider 71 and the lever bar 35 through the interior of the tubular upper portion 43 of the handle 30. With this arrangement, actuation of the lever bar 35 causes reciprocatory movement of the slider 71. A spring 82 biases the arrangement into a condition corresponding to the lowermost position of the slider 71.

The slider 71 is guided for each reciprocatory movement by way of guide means 91. The guide means 91 comprises guide surfaces 93 defined by the ends of the first slot 63 in the barrel 57 and guide tracks 95 mounted on the barrel 57 to captively guide the carriage portion 75 of the slider 71 through its reciprocatory motion.

Because of the angular relationship between the finger 74 of the slider 71 and the direction of travel of the slider, reciprocatory motion of the slider 71 along the second axis 72 causes the locking pin 51 to undergo reciprocatory motion in its axial direction along the first axis 52 between the release and engaging conditions. Specifically, upward movement of the slider 71 causes the locking pin 51 to move from the engaging condition to the release condition, and downward movement of the slide 71 causes the locking pin 51 to move from the release condition to the engaging condition.

As mentioned above, movement of the slider 71 is controlled by operation of the lever bar 35. The lever bar 35 is biased by the influence of spring 82 into a position which disposes the slider 71 in its lowermost position corresponding to the locking condition of the locking pin 51, as shown in FIG. 6. Pulling the lever bar 35 towards the handgrip 22 of the handle 10 lifts the actuating rod 81 to cause the slider 71 to move upwardly against the influence of spring 82 into its uppermost position corresponding to the release condition of the locking pin 51, as shown in FIG. 7.

From the foregoing, it is evident that the present embodiment provides a simple yet highly effective handle mechanism with incorporated lock which can be accommodated on the jack 11 notwithstanding space constraints.

It should be appreciated that the scope of the invention is not limited to the scope of the embodiment described. In particular, the handle mechanism according to the invention and also the lock forming part of the handle mechanism may have applications for mobile apparatus other than lifting jacks. Additionally, the lock itself may have applications in fields other than with the handle mechanism with which it has been described and illustrated.

Modifications and improvements can be made without departing from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A lock comprising a locking pin moveable axially along a first axis between engaging and release conditions, a slider adapted to undergo reciprocatory movement along a second axis substantially normal to the first axis, the slider being operably connected to the locking pin whereby movement of the slider along the second axis causes movement of the locking pin along the first axis.

2. A lock according to claim 1 wherein the slider presents a pair of opposed faces disposed angularly with respect to the second axis, the opposed faces being adapted for sliding engagement with abutment faces on the locking pin.

3. A lock according to claim 2 wherein the locking pin incorporates a slot in which the slider is received, the opposed faces of the slot defining the abutment faces.

4. A lock according to claim 2 further comprising guide means for guiding the slider during reciprocatory movement thereof.

5. A lock according to claim 5 wherein the guide means comprises a carriage defined by the slider confined between two opposed guide tracks.

6. A handle mechanism incorporating a lock according claim 1.

7. A handle mechanism comprising a handle pivotally moveable into and out of a first position and a lock for releasably locking the handle in the first position, the lock comprising a locking pin moveable between engaging and release conditions and an actuator operably connected to the locking pin whereby the locking pin is moveable from the engaging conditions into the release conditions upon operating of the actuator, the handle comprising a tubular shaft and the actuator comprising an elongate element accommodated within the tubular shaft, one end of the elongate element being operably connected to the locking pin and the other end of the elongate element being connected to an actuating device (such as an actuating handle).

8. A handle mechanism according to claim 7 wherein the elongate element comprises a rigid shaft.

9. A handle mechanism according to claim 7 wherein the locking pin is moveable axially along a first axis between the engaging and release conditions.

10. A handle mechanism according to claim 7, 8 or 9 wherein the lock further comprises a slider adapted to undergo reciprocatory movement along a second axis substantially normal to the first axis, the slider being operably connected to the locking pin whereby movement of the slider along the second axis causes movement of the locking pin along the first axis.

11. A handle mechanism according to claim 10 wherein the slider presents a pair of opposed faces disposed angularly with respect to the second axis, the opposed faces being adapted for sliding engagement with abutment faces on the locking pin.

12. A handle mechanism according to claim 10 wherein the locking pin incorporates a slot in which the slider is received, the opposed faces of the slot defining the abutment faces.

13. A handle mechanism according to claim 10, wherein guide means are provided for guiding the slider during reciprocatory movement thereof.

14. Apparatus adapted to be propelled across a surface, the apparatus having a handle mechanism according to claim 6.

15. Apparatus comprising a mobile portion and a handle mechanism for propelling the mobile portion, the handle mechanism comprising a handle pivotally moveable into and out of a first position with respect to the mobile portion and a lock for releasably locking the handle in the first position, the lock comprising a locking pin moveable between engaging and release conditions with respect to the mobile portion and an actuator operably connected to the locking pin whereby the locking pin is moveable from the engaging conditions into the release conditions upon operating of the actuator, the handle comprising a tubular shaft and the actuator comprising an elongate element accommodated within the tubular shaft, one end of the elongate element being operably connected to the locking pin and the other end of the elongate element being connected to an actuating device.

16. Apparatus according to claim 15 wherein the locking pin is moveable axially along a first axis between the engaging and release conditions, and wherein there is a slider adapted to undergo reciprocatory movement along a second axis substantially normal to the first axis, the slider being operably connected to the locking pin whereby movement of the slider along the second axis causes movement of the locking pin along the first axis, the slider being connected to the elongate element.

17.-19. (canceled)
